(19) United States
(12) Patent Application Publication
(10) Pub. No.: US 2006/0104281 A1
(43) Pub. Date: May 18, 2006

(54) Packet routing

(76) Inventors: Robert Walter Alister Scarr, Essex CM24 8LR (GB); William Alden Crossland, Harlow, Essex CM2 2QD (GB)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/520,186

(22) PCT Filed: Jun. 30, 2003
(86) PCT No.: PCT/GB03/02773

§ 371 Date: Aug. 24, 2005

(30) Foreign Application Priority Data
Jul. 4, 2002 (GB) 0215505.9

(51) Int. Cl. H04L 12/28; H04L 12/56

(52) U.S. Cl. 370/395.1; 370/401

(57) ABSTRACT

A packet router has an input stage (1), an output stage (15) and a coupling stage (10) for coupling the input and output stages. The input stage has plural input devices, the output stage has plural output devices and the coupling stage provides paths for signals between output elements of the input devices and input elements of the output devices. Each input device has circuitry arranged to respond to packet destination data of a packet received by its input device for adding, to the packet data of the packet, information indicative of a router output node at which the packet is to be output. The router has a controller (20) connected to the input stage and to the coupling stage for causing packets to be output to said coupling stage in dependence on this information. Each output device has circuitry for removing the information prior to output of packets. The router has a connecting device receiving signals from paths of the coupling stage and to transfer the signals to a further output device disposed remote from the input stage.

The present invention relates to a packet router, a network and a method of routing a packet

In this document, unless the context indicates the contrary, the term “packet” includes data packets of any type, and specifically includes ATM cells.

Routers containing multistage switches such as Banyan or Clos networks are known in the art. One problem with switches for circuit or packet switching is internal blocking. Internal blocking is a condition where it is not possible to find a free path from source to destination. Multistage switches such as the Clos 3-stage architecture which can be made to be strictly non-blocking in a circuit switching context will, with the same architecture, block in the packet switching context. However by increasing their dimensions, Clos and other multistage architectures can be made to become substantially non-blocking to the point where packet loss is low enough to be acceptable.

To accomplish very high data rates, for example for Internet traffic of the multi-terabit order, there has been proposed a hybrid electro-optical switch with optical fan-out, optical fan-in and optical shutters acting as the spatial path selection means. Optical sources are provided by vertical cavity surface emitting lasers (VCSEL) and silicon photodetectors provide the optical source terminations. For large switches it is advantageous to use free-space connections within the switch to provide the paths.

So as to be able to buffer or queue data, it is necessary to provide storage. A simple switch may use a conventional dual-ported RAM common to the packet inputs, with writing to memory of the data from each input in sequence using a demultiplexer or distributor. However, this is predicated upon sufficient time being available to write data from all inputs before new inputs have arrived. When the number of writes of data multiplied by the average access time per write exceeds the total access time of the memory, this technique can no longer be used without loss of data.

Clearly a major source of the problem lies in the memory write bus at the output of the demultiplexer, as this must be shared among all of the incoming packet sources. To avoid this problem, it would be possible to provide n memories for n input ports, but that would be prohibitively expensive, and complex. Instead, the inputs can be grouped into so-called “sectors” with, say, m inputs per sectors and each sector sharing access to a memory dedicated to the sector. Outputs are grouped in the same way.

Then, when a packet is received at an input and having a packet header indicating a desired output node, the packet data are transferred from the input sector containing the input to the output group containing the desired output node. The output module containing the output group then routes the packet data to the desired output.

This technique also allows the number of connections between the sectors to be less than the n×n connections needed to provide full connectivity between n inputs and n outputs.

The number of inputs per sector may be chosen on a memory bandwidth basis. However, other factors may come in such as choosing m to divide into n to produce an integer and preferably a power of two, e.g. 16 or 256.

Queuing has the further disadvantage of introducing delays into the transmission.

Networks are often categorised into three types:
LANs—Local Area Networks
MANs—Metropolitan Area Networks
WANs—Wide Area Networks

The LAN is a very common type of data network. A LAN:

is local (i.e. one building or group of buildings.

is controlled by one administrative authority.

assumes other users of the LAN are trusted.

A WAN is usually a network covering a large geographical area, using communications circuits to connect the intermediate nodes. The communications circuits of most WANs are owned by or leased from telephone companies or other communications carriers. The characteristics of WANs lead to an emphasis on efficiency of communications techniques. Controlling the volume of traffic and avoiding excessive delays is important.

The MAN has three important characteristics:

1. The network size falls intermediate between LANs and WANs. A MAN typically covers an area of between 5 and 50 km diameter. Many MANs cover an area the size of a city, although in some cases MANs may be as small as a group of buildings or as large as the North of Scotland.

2. A MAN (like a WAN) is not generally owned by a single organisation. The MAN, its communications links and equipment are generally owned by either a consortium of users or by a single network provider who sells the service to the users.

3. A MAN often contains a number of packet routers and acts as a high speed network to allow sharing of regional resources (similar to a large LAN). It is also frequently used to provide a shared connection to other networks using a link to a WAN.

Another important characteristic of a MAN is that it may use network-specific addressing for packet transmission within the MAN rather than relying on the global IP address. Typically the MAN contains routing tables under control of a network controller to determine how a packet should pass between two nodes of the MAN. These routing tables are likely to be variable according to traffic conditions. Local addressing is employed as it is shorter than full IP addressing.

Other types of network have characteristics crossing the above bounds. For example, wholly owned networks (c.f. LANs) may cover large geographical areas (c.f. WANs).

Among the problems of prior art networks and routers are those of control and time delay. It is desirable to have local control that allows operation of a router to take place without the need for real-time intervention by the network controller. It is also desirable to provide architectures in which the number of queues can be kept low to avoid adding delays. As queue management presents an appreciable control overhead, it is also desirable to reduce the number of queues to enable simpler control systems.

According to a first aspect of the invention there is provided a packet router comprising an input stage, an output stage and a coupling stage for coupling the input and output stages,

the input stage having plural input devices each for receiving packets having packet data comprising packet destination data, each input device having at least one output element;

the output stage having plural output devices defining plural router output nodes, each output device having at least one input element;

the coupling stage providing paths between said output elements of the input devices and said input elements of the output devices;

wherein each input device has circuitry arranged to respond to packet destination data of a packet received by said input device for adding, to the packet data of the packet, information indicative of a router output node at which the packet is to be output;

wherein the router further comprises a control device connected to said input stage and to said coupling stage for causing packets to be output to said coupling stage in dependence on said information;

wherein each output device has circuitry for removing said information prior to output of packets; and

wherein the router further comprises a connecting device arranged to receive said signals from paths of the coupling stage and to transfer said signals to a further said output device disposed remote from said input stage.

In the context of a MAN, the router input devices may be in one building for example, with some output devices in the same building and the further output device in another building. The links between the inputs and outputs may then be controlled by the router control device. This means that local control can provide good use of the links, and may reduce the number of connections between the buildings by comparison to a conventional network.

The provision of an output device which is remote from the input stage allows flexibility in use of the connections between the input stage and output devices. In a conventional router, connections from the router to each destination device will need to be dimensioned to accept the largest expected traffic, if delays are not to occur. If each of say four destination devices have a peak traffic flow which requires two lines from the router output, then eight such lines will be required. With the present router the output device may be physically close to the destination devices. A connecting device with only, for example, six paths may suffice provided high traffic conditions do not occur to all the destinations simultaneously.

In one embodiment said coupling stage is arranged to vary the paths between the input stage and the output stage, and said control device is arranged to cause packets to issue from the input stage when a desired path is provided.

In this embodiment the coupling stage may for example automatically cycle between different path combinations without being fully controlled by the control device. Alternatively the network controller controls the coupling stage to cause reconfiguration when the traffic flow varies at the macro level, for example when a change in the statistics of the traffic occurs. In both these cases, and in other cases where the coupling device does not respond directly to the needs of individual packets, the control device only has to release data when an appropriate path is provided.

In another embodiment said control device is arranged to control the coupling stage to set up a desired path from the input stage to the output stage and to cause packets to issue from the input stage for the desired path.

In this embodiment, the control device controls the coupling stage either in dependence on the presence of particular individual packets, or in dependence upon a sensed queue condition or in other ways so as to set particular paths through the coupling stage. Once the desired paths are achieved, packets then issue for them.

In some embodiments the coupling stage is arranged to provide at least one fixed path.

The computing overhead of the control device can be reduced by providing one or more fixed paths through the router. In such embodiments, the controlled paths through the coupling stage may be used to smooth out traffic flows.

In one embodiment, the input devices comprise segmenting circuitry arranged to divide received packets into segments of common length prior to application to said coupling stage, wherein each segment includes the said information and the output devices comprise de-segmenting circuitry arranged to assemble segments received from said coupling stage into packets.

By segmenting the packets there are three major advantages. One is the ability of the router to cope with packets or arbitrary length, the second is to enable the efficiency of the device to be high and the third is to match the segment length to the width (word length) of the internal memory such as a standard value of 128 bits.

In this respect, if the segments are similar in length to the minimum packet or cell size there will be no need to transmit large numbers of stuffing bits, such as would be required if the window for packet transmission were equal to the maximum packet length.

In some embodiments the input devices have optical output elements, the output devices have optical input elements and the coupling stage is arranged to provide free-space optical paths between said optical output elements and optical input elements.

The use of free-space optical paths provides a less expensive and more flexible technique than would be required by optical fibres. The ability to include simple controlled gating devices in the optical paths means a substantial power reduction by comparison with similar electrical devices. Cross-talk is also less than would be the case in electrical embodiments.

The connecting device may comprise a passive optical network.

The input stage may have a plurality of inputs capable of carrying a first plurality of packets to said router in a given time period, and the coupling stage is capable of providing said paths between said output elements of the input devices and said input elements of the output devices, wherein said paths are arranged to be able to carry more than said first plurality of packets in said given time.

Conveniently the number of spatially separate paths provided by said coupling stage is greater than the number of inputs to said input stage.

According to a second aspect of the invention there is provided a network comprising a packet router wherein each input device comprises storage for holding queues of packet data prior to issue to said coupling stage, and each output device has storage for queues of packet data received from the coupling stage, and further comprising at least one second packet router having a second router input stage, a second router output stage and a second router coupling stage for coupling the second router input and output stages, wherein the second router input stage has plural input devices each for receiving packets having packet data comprising packet destination data, each second router input device having at least one output element and storage for holding queues of packet data prior to issue to said second router coupling stage, wherein the second router output stage has plural output devices defining plural output nodes, each output device having at least one input element, wherein the second router coupling stage is arranged to provide paths between said output elements of the input devices and said input elements of the output devices, and wherein at least one of the input devices of the second router input stage is provided by said further said output device of said packet router disposed remote from said input stage of said first packet router, each said queue of packet data received from the coupling stage of the first packet router forming a queue of packet data prior to issue to said second router coupling stage.

In this aspect, the invention allows for one router to have a remote output which is the input to another router. Apart from allowing flexibility of utilisation of the paths, this also results in queue number reduction. It is possible to do this because the claimed architecture allows for immediate control to be needed only in the input and coupling stages, with there being no requirement for the output stage or output device to communicate with the input stage or coupling stage at the packet level.

The network contains a plurality of routers. Of this plurality the first router is connected to only a second router of the type defined in one embodiment. However, in other embodiments, the first router may be connected to any number of second routers up to a number equal to the number of segments in the first router.

According to a third aspect of the invention there is provided a network comprising a first and at least one second packet router, each packet router comprising an input stage having plural input devices, an output stage having plural output devices and a coupling stage for providing paths between said input devices and said output devices; each input device having storage for holding queues of packet data prior to issue to said coupling stage, each output device having storage for queues of packet data received from the coupling stage; wherein at least one of the input devices of the second packet router is provided by an output device of said first packet router such that each said queue of packet data received from the coupling stage of the first packet router forms a queue of packet data prior to issue to said coupling stage of said second router.

Again, the network contains a plurality of routers. Of this plurality the first router is connected to only a second router of the type defined in one embodiment. However, in other embodiments, the first router may be connected to any number of second routers up to a number equal to the number of segments in the first router.

Each packet router may have a respective control device connected to its input stage and to its coupling stage for outputting packets to said coupling stage in dependence on routing information carried by packets.

The coupling stage of at least the first packet router may be arranged to optically couple the input stage of the first packet router to the output stage of the first router.

The said coupling stage may be arranged to provide free-space connections.

According to a fourth aspect of the invention there is provided a method of routing packets using a packet router comprising an input stage, plural output devices and a coupling stage for coupling the input stage and output devices, wherein at least one of the output devices is spatially remote from the coupling stage;

the method comprising:—

in said input stage, examining packet destination data of a packet received by said input stage and in response thereto

adding, to the packet, router information indicative of a router output node of said at least one of said output devices, at which the packet is to be output to provide enhanced packet data;

in dependence on said router information, determining whether a path is available from an input of said coupling stage to an output connected to said at least one output device;

outputting said enhanced packet data to said input of said coupling stage, whereby the enhanced packet data is carried to an output of said coupling stage for said at least one output device having the said router node;

receiving the enhanced packet data from said coupling stage output and transferring the packet data over a link to said at least one output device;

receiving said enhanced packet data in the said output device;

removing said router information; and

outputting said packet at said router output node.

According to a fifth aspect of the invention there is provided a method of routing packets using a router comprising an input stage having plural output elements, plural output devices each having plural input elements, the plural output devices each having a plurality of output nodes, said output nodes together defining the output nodes of said router, and a coupling stage for coupling the plural output elements of the input stage to plural coupling stage outputs, wherein at least one output device is spatially remote from the coupling stage and the router further comprises a link between predetermined outputs of said coupling stage and the plural inputs of said at least one output device;

the method comprising:—

receiving respective packets at each of plural inputs of said input stage;

in response to packet destination data of said packets, adding to each packet respective router node information indicative of a router output node at which the said packet is to be output, thereby to form enhanced packet data comprising said packet data and said router node information;

storing said enhanced packet data for each packet in a common input memory;

in dependence on said router node information indicative of an output node in said at least one output device, determining an available path through said coupling stage from an output element of said input stage to one of said predetermined outputs of said coupling stage;

outputting said enhanced packet data from said common input memory to said output element, whereby the enhanced packet data is carried to one of said predetermined outputs of said coupling stage;

transferring the enhanced packet data over said link to one of said plural inputs of said at least one output device;

receiving said enhanced packet data at the said output device;

removing said router node information indicative of said output node to form packet data;

storing said packet data in a memory common to the input elements of said output device and to the output nodes of said output device; and

outputting a packet at said router output node from said memory.

The method may comprise varying paths provided by said coupling stage between the input stage and the output stage, and causing packets to issue from the input stage when a desired path is provided.

The varying step may comprise providing a sequence of path combinations, and selecting between said path combinations on a timed basis.

In one embodiment said varying step comprises providing a sequence of path combinations, and selecting between said path combinations in accordance with a statistical analysis of traffic in said router.

In another embodiment the method comprises controlling the coupling stage to set up a desired path from the input stage to the output stage and issuing packets from the input stage to the desired path.

In some embodiments, the coupling stage is arranged to provide at least one fixed path.

The method may comprise dividing received packets into segments of common length prior to application to said coupling stage, and adding the said information to each segment; and assembling segments received from said coupling stage into packets.

The method may comprise coupling between the input stage and the output devices by free-space optical paths.

The transferring step may be carried out using a passive optical network.

The method may comprise carrying packet data across said coupling stage faster than said packet data is received at said input stage.

The method may comprise providing a number of spatially separate paths in said coupling stage wherein said number is greater than a number of inputs to said input stage.

The method may comprise:

holding queues of packet data prior to issue to said coupling stage,

holding queues of packet data received from the coupling stage,

locating at least one of said queues of packet data received from the coupling stage at an input of a second router having a second router coupling stage, said second router holding queues of packet data prior to issue to said second router coupling stage, and using said at least one of said queues as a said queue of packet data prior to issue to said second router coupling stage.

An embodiment of the invention will now be described with reference to the accompanying drawings in which:—

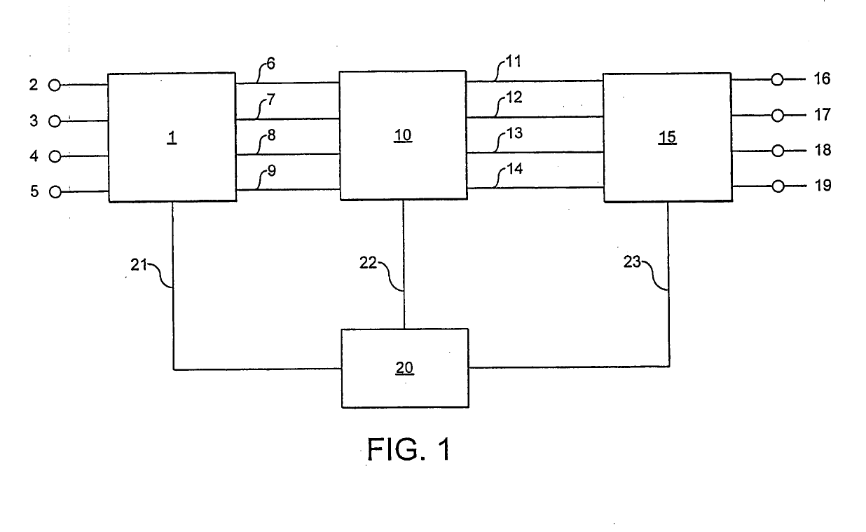

FIG. 1 shows a block schematic diagram of a packet router useful in understanding the present invention;

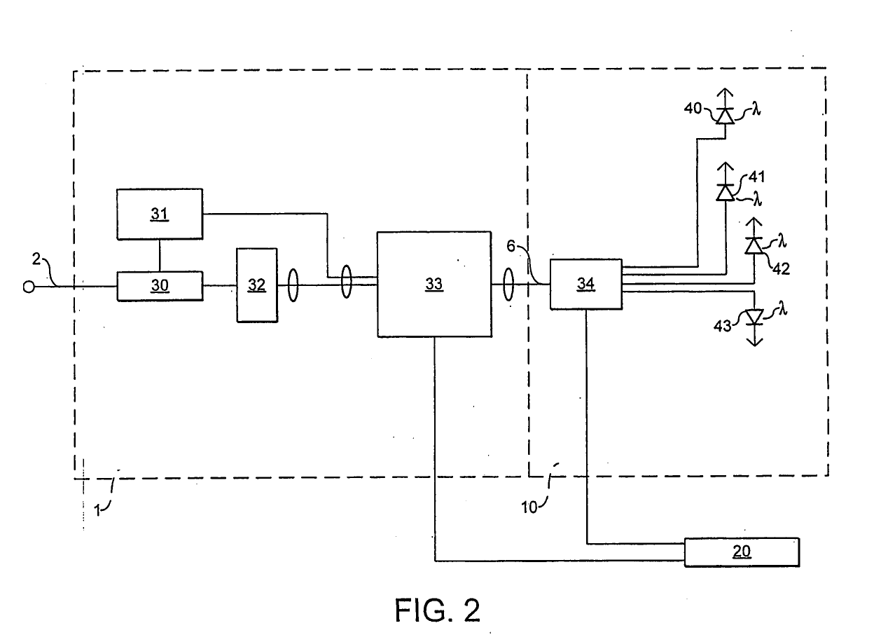

FIG. 2 shows a more detailed schematic diagram of the input side of FIG. 1;

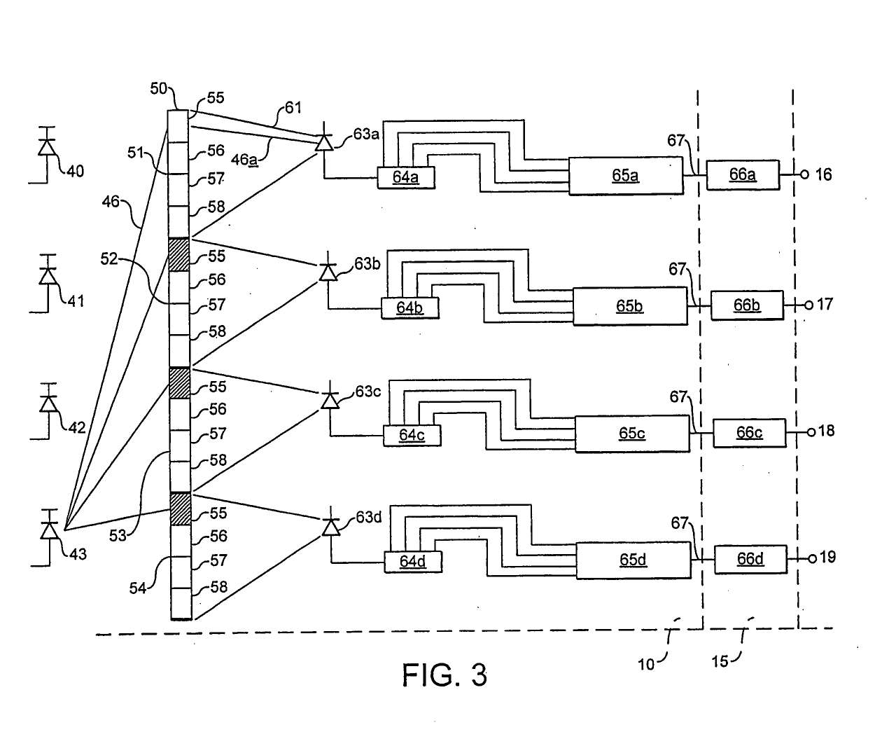

FIG. 3 shows a more detailed schematic diagram of the output side of FIG. 1;

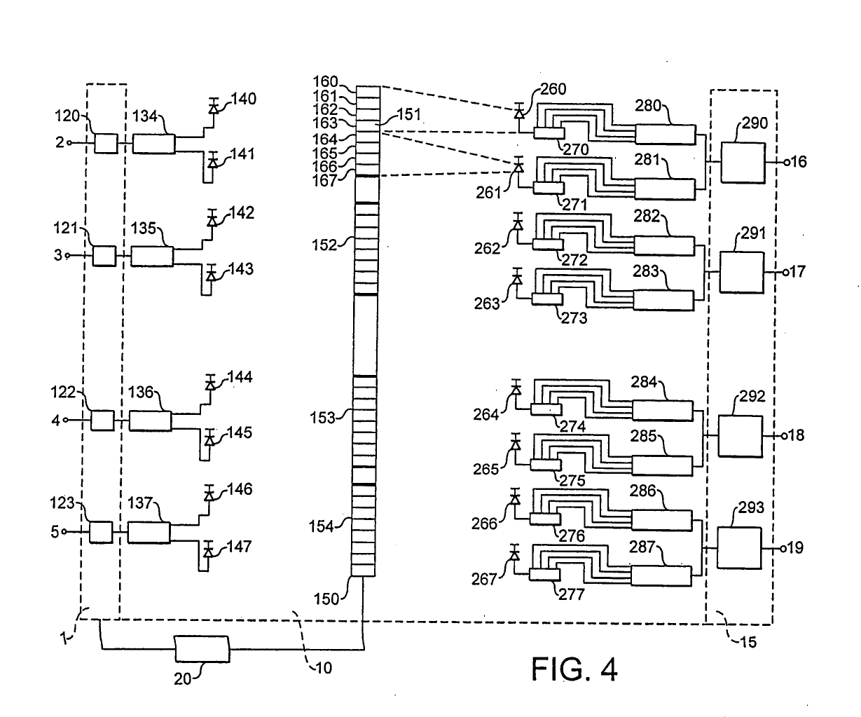

FIG. 4 shows a schematic diagram of a router, for explaining the concept of ‘speed-up’;

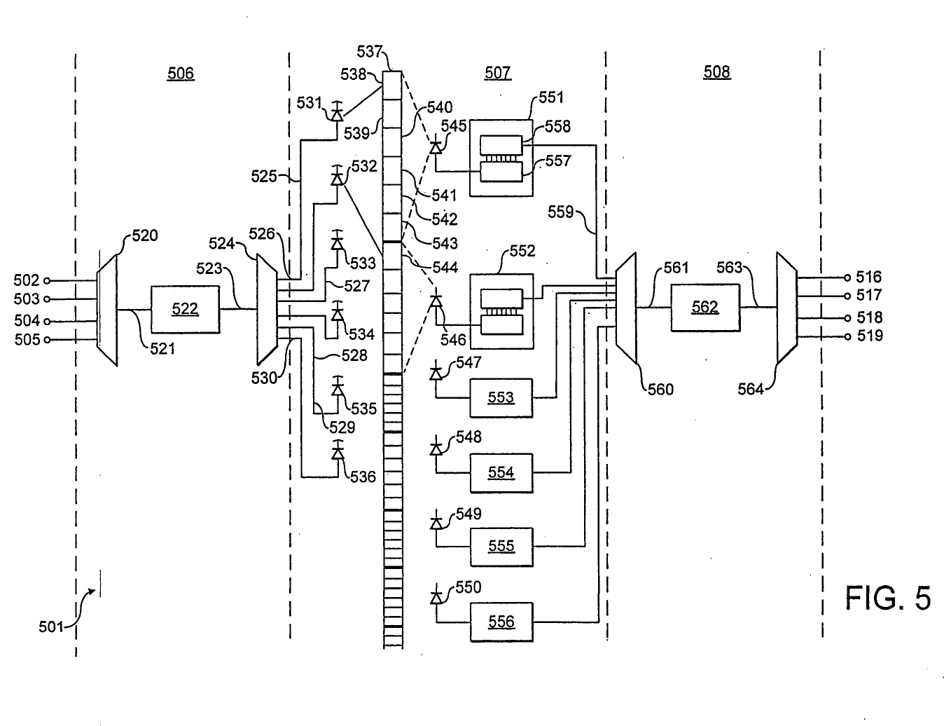

FIG. 5 shows a schematic diagram of a router, for explaining the concept of sectoring;

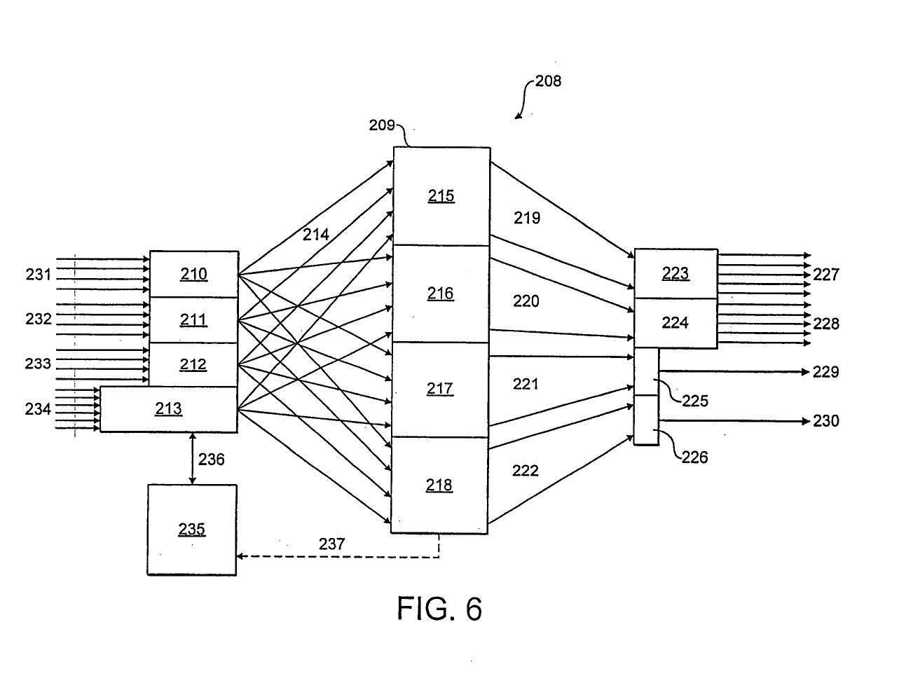

FIG. 6 shows a schematic diagram of a further example of a packet router,

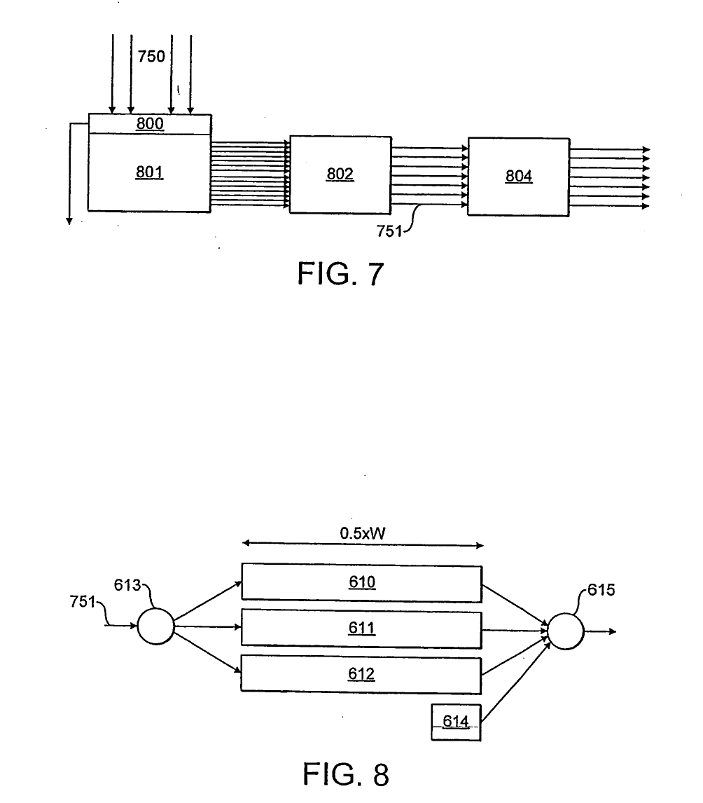

FIG. 7 shows a high-level block diagram of control of one sector of the input stage to the core switch of a sectored router;

FIG. 8 shows a block diagram of an example of a re-timing buffer;

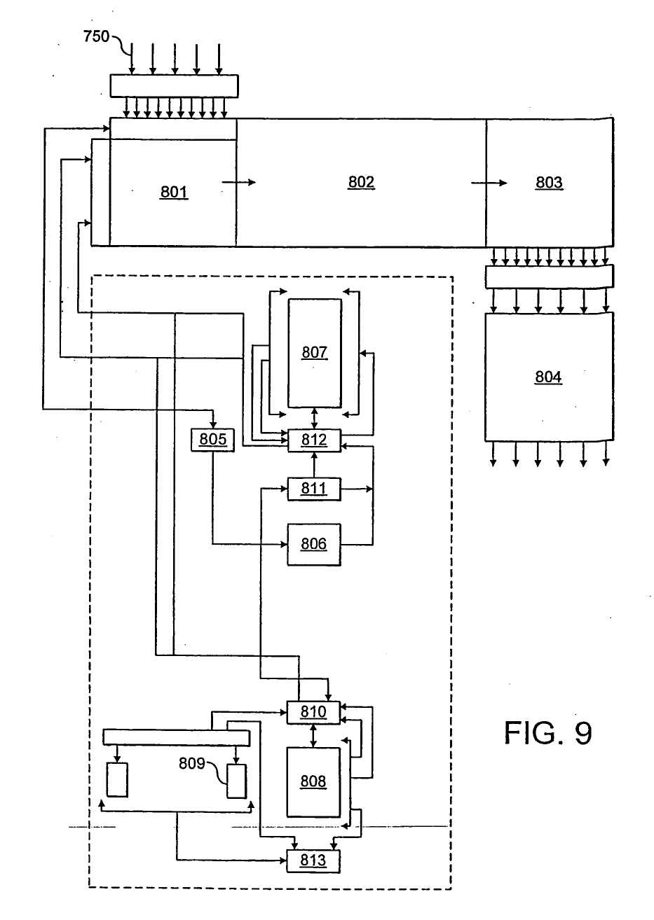

FIG. 9 shows an example of an implementation of FIG. 7;

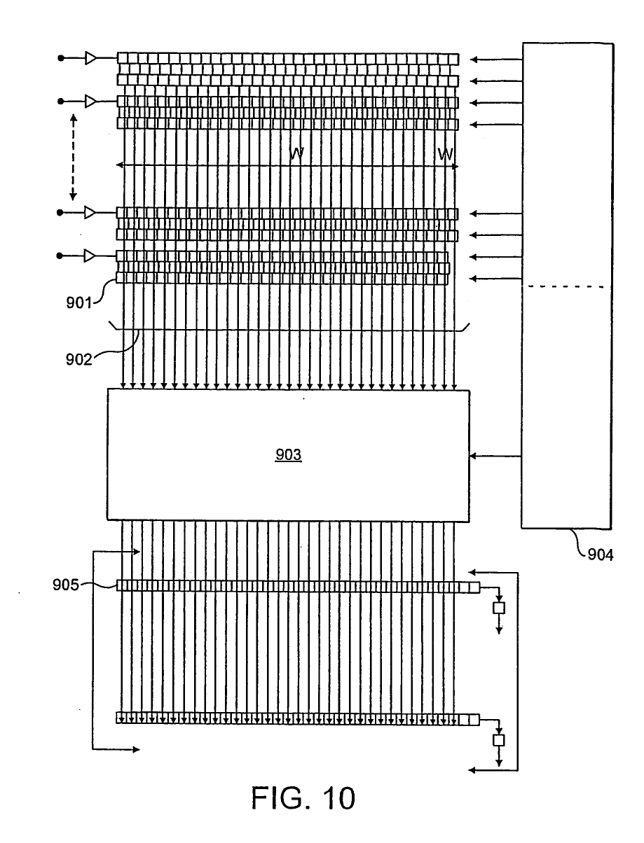

FIG. 10 shows a block schematic diagram of an output stage electronics arrangement;

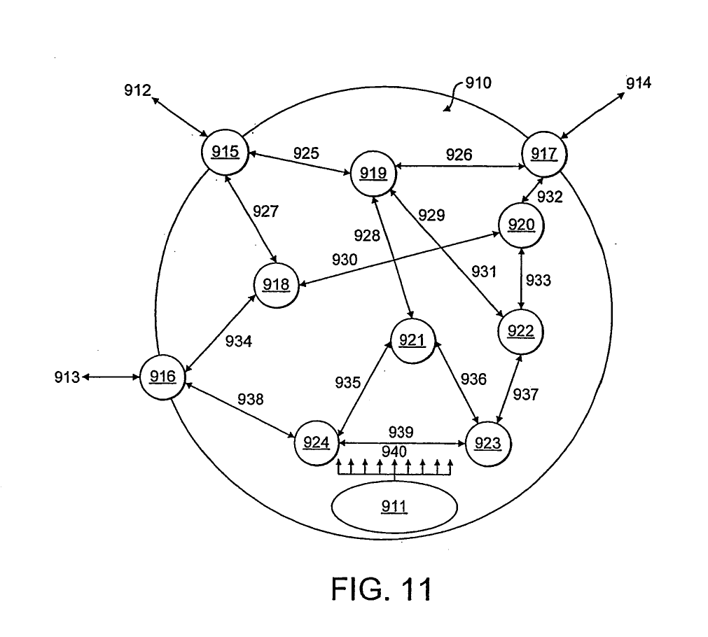

FIG. 11 shows a block schematic diagram of a Metropolitan Area Network; and,

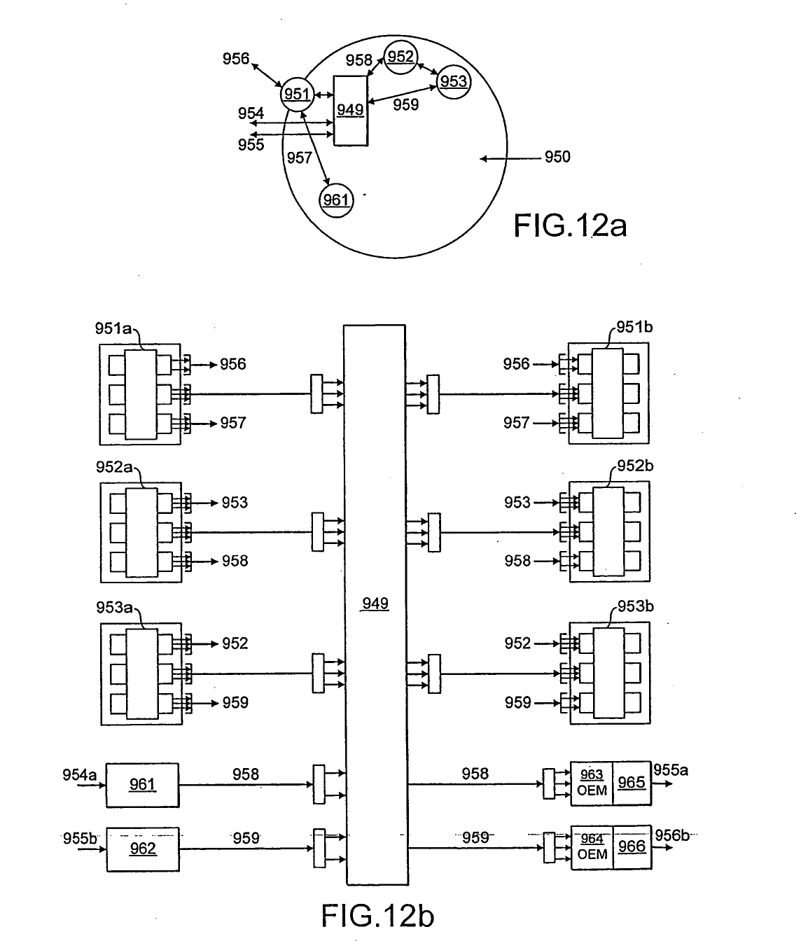

FIG. 12 shows a block schematic diagram of a router in accordance with the invention in a MAN.

In the various figures, like reference numbers refer to like parts.

Referring to FIG. 1 an exemplary packet router useable in a MAN has three stages 1, 10 and 15. The first stage 1 receives signals from four input lines 2-5 of the MAN, carrying packet data. In the embodiment shown in FIG. 1 the first stage 1 has four output lines 6-9 which form the input lines to the second stage 10, hereinafter referred to as the core switch. The core switch has four output lines 11-14 which form the inputs to the third stage 15, the output stage, which in turn has four output lines 16-19. A control unit 20 is local to the router, in the sense that its connections to the router allow it to respond to router conditions in real-time. The control device has connections 21, 22 and 23 connected to respectively the first, second and third stages of the router.

The functions of the first stage 1 include sorting packet data according to the output port of the router to which the packet is to be routed, and queuing the sorted input packet data in local buffers until the core switch 10 is able to carry them to the output stage 15. The core switch has the function of delivering information provided at each one of the four core switch inputs to core switch outputs. The output stage has the main function of holding data received from the core switch for output.

Each of the input packets includes network header information which indicates the destination network address of the packet, and which determines which of the router output lines 16-19 the packet is to be routed to. The router operates using data of a fixed number of bits, and input packets with more bits than the fixed number are segmented by the first stage 1 into segments having the fixed number of bits, with stuffing bits where needed. To each segment there is added a local header indicative of the router output line destination of the segment and each segment is stored in a buffer for onward transmission when a path towards that output line becomes available in the core switch.

The third stage 15 receives data over lines 11-14 from the core switch, and holds the data until a complete packet is available. Then it reassembles the packet and stores the packets until the appropriate one of the output lines 16-19 is available to output data. The stored information in the first stage 1 is termed an input queue and the stored information in the third stage 15 is termed an output queue.

In this example, the core switch 10 operates to interconnect its input lines 6-9 with its output lines 11-14 according to control exerted by the control unit 20.

Assuming that all of the lines have the same capacity for carrying information then the switch shown in FIG. 1 has no speed-up, i.e. lines 6-9 cannot remove information from the totality of the input queues stored in the buffers of the first stage 1 any faster than that information is provided to the input lines 2-5. In other examples there are more lines between the first stage 1 and the core switch 10 and the core switch 10 and the third stage 15 than there are input and output lines. Such embodiments provide spatial speed-up so that packet data can be removed from the input queues more rapidly than the packet data is applied. It would alternatively be possible to provide temporal speed-up, or a wavelength division multiplex.

Continuing to refer to FIG. 1, the control device 20 monitors the size of the input and output queues and reconfigures the interconnections of the core switch in some defined way in response to those queues. In another embodiment, the interconnections of the core switch change either cyclically or according to the statistical conditions of the traffic in the network, and the control device sends packets to the core switch when a desired path is provided.

In the context of a MAN the network as a whole also has a network controller which manages the information flow within the network typically to avoid hotspots as far as possible. The network controller is remote from the routers that make up the network and thus is capable only of management rather than control at the individual packet or stream level.

FIG. 2 shows the part of the input stage 1 of FIG. 1 which is connected to input line 2, together with a part of the core switch 10 of FIG. 1. Similar connectivity is provided for each of the other input lines 3-5.

Referring now to FIG. 2, the input line 2 connects to header reading circuitry 30 of the input stage 1, which reads the header information from incoming packets on the line 2. In the context of a MAN, this header information is MAN address data, not the IP address. After reading, this header data remains in the packet as part of the packet payload. The packet is passed through the header reading circuitry 30 to a segmenting circuit 32 which includes a serial-to-parallel converter stage that outputs bit-parallel data of standard width towards a dual-port memory 33. The extracted header information is fed to local header circuitry 31, which has a look-up table storing local headers indexed by packet address, and which provides an output to the memory 33. The output is a local header indicative of the output port of the router to which the packet is destined. Assuming a memory width of 128 bits the segmenting circuitry 32 might for example provide a bit-parallel output of 120 bits and the local header circuitry 31 provides 8 bits, the 8 bits being maintained identical for each of the segments of the packet and stored with each of those segments in the memory.

The second port of the memory 33 is a read output and is connected to line 6 of the core switch. This in turn is coupled to a selector 34 under control of the control circuit 20. The outputs of the selector 34 are connected to four VCSELs 40-43.

As noted above each of the inputs 2-5 has associated header reading circuitry 30, local header circuitry 31, and segmenting circuitry 32 as shown in FIG. 2. It is possible to provide one memory 33 for each input 2-5 and this avoids memory bus contention. It may alternatively be desirable to provide fewer memories than this by the process of “sectoring” the inputs to the memory 33. In the device later described with respect to FIG. 4 each sector has four inputs and each sector has a single memory.

Sectoring has the further advantage that the flexibility of the device is improved, as follows. Each input sector has more than one output, all accessible from any packet in the input sector's common memory and each output sector has more than one input which can access the output sector's common memory. The paths through the coupling device are not dedicated to particular output nodes as they are in a non-sectored device, as the coupling device only needs to provide a path between one of the input sector's outputs and one of the output sector's inputs for packets to be transferred to the output sector's common memory. The output sector's common memory then acts as a common memory switch and is accessed at a read port by a selector to connect the packet data to the desired output node of the sector.

The device shown in FIG. 2 is non-sectored and thus the memory 33 is connected only to input 2, and further memories are provided for each other input. These memories have outputs to the selector 34 similar to line 6.

Referring again to FIG. 2, the line 6 from the memory 33 to the selector 34 is capable of carrying bit-serial outputs from the memory 33. Each bit-serial output is routed by the selector to a respective VCSEL 40-43. The controller 20 is aware of the present flow of information within the system and the state of the queues in the memory 33 and operates the selector 34 in some predefined way, for example to minimise overall queuing time. The segments of each packet are supplied to a respective VCSEL so that an entire packet is output to a single VCSEL. In one embodiment the contents of an entire queue, which may contain several packets, are supplied to the VCSEL for transfer through to the core switch.

Referring now to FIG. 3 which shows a part of the core switch 10 of FIG. 1 and the output stage 15 of FIG. 1, with an exemplary VCSEL 43 outputting light 46. It will be understood that in practice all VCSELs are likely to be operating simultaneously. In the figurative representation of FIG. 3 the light is shown as having four different directions representing “fan-out”. Fan-out may be achieved in a number of ways known to those skilled in the art, for example by lenses, by lenses and holographic gratings or by holographic gratings alone. Also it is possible to use optical fibres to provide fan-out. It is however preferred to use free-space fan-out as this is less complex and less costly.

The light is incident on a path controlling device 50 which here is a multiple shutter device for example a ferroelectric liquid crystal shutter matrix. Continued inspection of FIG. 3 shows that the shutter device is divided up into four sections 51-54 and that each section of the shutter comprises four individual shutters 55-58. The number of shutters per section corresponds to the number of VCSELs and the number of sections corresponds to the number of inputs or input sectors. Each VCSEL is incident on a respective one shutter in each section, by virtue of the fan-out optics and for ease of explanation the VCSEL 43 is shown as linked to the first shutter in each section. In each section 51 therefore the light from VCSEL 43 is incident upon shutter 55. The remaining shutters 56, 57 and 58 receive light from the other VCSELs 40, 41 and 43.

As noted above the physical arrangement of the shutters is not as shown diagrammatically. The VCSEL 43 may for example provide a beam onto a rectangular array of shutters, the beam being incident upon four adjacent shutters with each other of the VCSELs 40-42, 44 and 45 being incident upon a different four shutters from the array.

Each shutter section 51-54 is connected via fan-in optics 61 to a respective one of four photodiodes, 63a-d. The photodiodes 63a-d detect incoming light, convert it into an electrical signal and apply it to the serial input of a respective serial-to-parallel converter 64a-d which have bit-parallel outputs connected to a write port of a respective dual-port buffer 65a-d. The read port 67 of each buffer 65a-d is connected via a respective parallel bus 67a-d to processing circuitry 66a-d whose outputs 16-19 form outputs of the router.

The control circuit 20 is connected to the shutter array 50 so that only one shutter per section is opened. In the present case shutter 55 of section 51 is opened and the remainder are closed.

Operation of the device of FIGS. 1, 2 and 3 will now be described.

As previously noted an input packet at input 2 is stored in memory 33 in the form of segments, each segment having an added local header indicative of the final destination port of the router—here node 16. The memory will also contain further packets held as segments with local headers indicative of other output ports. Information such as the length of the queue and the time of arrival of the earliest packet is provided from the memory to the control circuit 20. The control circuit 20 also contains similar information concerning the queues in the memories from the other inputs 3-5. Furthermore the control circuit also contains information about the present state of the shutter array 50 and by virtue of this information is aware of which of the VCSELs 40-43 is currently transferring information to the photodiode 63a. As shown in FIG. 3, the control circuit 20 is further aware of the state of the queues in the output buffers 65a-d. It is however possible to dispense with this information at the local level as will later be described herein.

On the basis of some queuing strategy the control circuit 20 routes information from the memories in the input circuitry 1 to the selector 34 and thence to the VCSELs 40-43. In one arrangement packets are taken from each memory during every time slot so that selector 34 will always take packets from each of the memories and route the packets of each memory to a respective single VCSEL.

It must be borne in mind that contention may occur in that at the time the subject information stored in memory 33 requires to be transmitted to photodiode 63a the photodiode 63a is already receiving information from another VCSEL. The control circuit 20 will be aware of the current state of the shutters which indicates which of the VCSELs, if any, is transmitting to diode 63 and will take the necessary action. This action may be retaining the information in the queue and instead transferring other information from memory for which there is a path available.

In the presently described example there are four inputs to the device and there are four paths within the core switch 10. It will however be recalled that it is possible to provide further paths within the core switch so as to provide spatial speed-up. This will be described later herein with respect to FIG. 4.

In the present case, by way of an example it is assumed that VCSELs 40-42 are involved in carrying packets towards the outputs 17-19. This means that one of the shutters of section 52 is enabled, one of the shutters of section 53 is enabled and one of the shutters of section 54 is enabled. As at the present time no information is being carried towards output 16 all of the shutters 55-58 of section 51 are dark whereby no light reaches the photodiodes 63a. The control circuit has stored information which consists of a map showing that when VCSEL 43 is to carry information towards output 16, then shutter 55 of section 51 is to be opened to transmit light. The control circuit also maintains dark shutters 55 of sections 52-54 so that the light incident from the VCSEL 43 on those shutters cannot reach inappropriate outputs. It should be borne in mind that under certain circumstances it may be desirable for a VCSEL to provide light to more than one output for multicast or broadcast purposes and in this case the control will be implemented accordingly.

Light passes through the shutter 55 of the first section 51 and is output as light 46a. This is guided by the fan-in optics to the photodiode 63a as a time series of pulses and these are passed to the serial input of the serial-to-parallel converter 64a The bit-parallel outputs of the converter 64a are applied to the write input of the buffer 65a until a complete packet has been received. The packet information is then fed out over read bar 67 to the processing circuitry 66a which de-segments the packet information and removes the local header data before outputting over the line at terminal 16. The processing circuit 66a may if required queue the packet.

Referring now to FIG. 4 an example of a non-sectored router will be described in which the core switch 10 has spatial speed-up. Referring to FIG. 4, the four inputs 2-5 each feed respective circuitry 120-3 having the function of circuitry 30-3 of FIG. 2, including the queue store. The output of circuitry 120-2 feeds respective selectors 134-7. Each selector 134-7 has two outputs. Each output is connected to a respective VCSEL 140-7. The VCSELs are disposed to provide light onto a shutter device 150 via fan-out optics. The shutter device has 4 sections, 151-4, and each section has two groups of four shutters, 160-3, 164-7. The fan-out optics here provides free-space paths, and consists of lenses. In other embodiments, gratings or combinations of gratings and lenses are used. The free-space paths are such that light from each VCSEL is incident on a respective predetermined one shutter of each shutter section.

On the other side of the shutter device 150 fan-in optics fans-in light from each shutter section to two optoelectronic diodes, such that light from each group of four shutters is guided to a respective diode from eight such diodes 260-267. Each diode has a respective shift register 270-277 connected at its data input to receive the serial data output of the diode, and each shift register has taps for bit-parallel read-out of the data, the bit-parallel data being fed to a respective buffer store 280-287. The buffer stores 280-287 are shown as connected in pairs to four circuits 290-293, each including output queuing circuitry and each connected to a respective output lime 16-9.

The control circuit 20 is connected to the input circuit 1 and to the shutter device 150. The control connection from the control circuit 20 to the shutter matrix 150 may make use of an additional VCSEL, to avoid the need for wiring.

In use, consider input packet data at input line 2 which is to be sent to a destination accessible from output line 16. The packet data has an IP address header as part of its payload, and a network address. The circuitry 120 accesses the network address, and by consulting a routing table which may be in the circuitry 120 itself or in the control circuit 20, a local header is derived indicative of output line 16. The circuitry 120 then segments the packet data and queues it in buffers.

The control circuit 20 checks the state of the shutter device 150, and checks whether VCSELs 140 and 141, both accessible from circuitry 120, are both occupied. If so, the packet data remains queued. Equally if the shutter state and emission state of other VCSELs indicates that the paths to the diodes 260, 261 are blocked by other traffic, the packet data remains queued.

Once the two conditions are satisfied of an available VCSEL and an available path, the queued data is selected by the selector and sent to the free one of the VCSELs 140,141. The shutter appropriate to the VCSEL for use in the shutter section 151 is then opened and the data sent across the core switch as a serial stream. In this case all data in the queue are sent. If the diode 260 is set to receive the stream, the data arrive at shift register 270 and are de-serialised before storage in buffer 280. Once a whole packet is available, the local header data may be removed from the segments of that packet and the reconstituted packet transferred to the store 290 into an output queue.

It should be noted that the presence of speed-up allows data to leave the input queue faster than it arrives there. It also allows greater flexibility and greater freedom from blocking.

As in the present embodiment the whole queue for a particular output line is emptied through a single connection of the core switch, it is not possible for both VCSELs 140, 141 to be sending information directly to the same output line 16 although two packets could be sent via 507 with one direct and the other queued in 281 or 282. In embodiments where packets are sent individually, it would be possible for both VCSELs to carry data for the same destination, but measures would have to be taken to ensure that packets leaving the router for the same end destination leave the router in the order received.

Referring now to FIG. 5 a single sector 501 of a sectored router is shown. Each sector has four inputs 502-505 and four outputs 51&519. Each sector consists of an input stage 506, a core switch stage 507 and an output stage 508. The input stage 506 and the output stage 508 consist generally of common memory switches having, in the case of the input stage four inputs and six outputs and, in the case of the output stage, six inputs and four outputs. The common memory switches each include an input demultiplexer having a bit-parallel output which is connected to the write bus of a dual-port memory, whose second port is connected to a multiplexer providing the stage output. In the case of the input stage 506 a demultiplexer 520 receives the four inputs 502-505 as its inputs and provides a bit-parallel output on a bus 521. The bit-parallel output is provided to a block 522 which contains header translation circuitry, segmenting circuitry and a memory as previously discussed with respect to earlier figures. The memory read bus 523 forms the input to a multiplexer 524 which has six outputs 525-530. Each of the output lines goes to a respective one of six VCSELs 531-6. The VCSELs are connected by fan-out optics to a shutter unit 537. The present router has six input and output sectors and to provide the necessary connectivity together with a speed-up of 1.5 (due to there being six VCSELs per four inputs) the shutter unit 537 has six groups of six shutters per sector. In FIG. 5 the first group of shutters is shown as 538-543 and the first shutter of the second group is shown as 544. For a 24×24 switch there will accordingly be 216 individual shutters. The first VCSEL 531 is connected via the fan-out optics to the shutter 538 of the first group and to no other shutters in the sector. It is however connected via the fan-out optics to one shutter of one group of each of the other sectors as well. The second VCSEL 532 is connected to the first shutter 544 of the second group of shutters in the sector shown in FIG. 5 but is connected via the fan-out optics to no other shutter in the sector shown although it is also connected to one shutter in each of the other sectors, a different shutter to that to which VCSEL 531 is connected. The second shutter 539 is illuminated by a VCSEL in the second sector, the third shutter 540 being illuminated by a VCSEL in the third sector and so on. Any light which is passed by the first group of shutters 538-543 is collected by fan-in optics onto an opto-electronic diode 545 of six such diodes 545-550. Each of the diodes 545-550 provides an input to a respective circuit block 551-556. The circuit blocks 551-556 are substantially identical and hence only block 551 will be described. The block 551 has a shift register 557 having a serial input and plural taps, the serial input being connected to the respective diode 545 and the plural taps being connected to a buffer 558. The buffer has a bit-parallel output 559 which forms an input to the output stage 508. The output stage 508 has a six-input demultiplexer 560 which has a bit-parallel output 561 to a circuit block 562 which includes de-segmenting circuitry and a dual-port memory. The dual-port memory has a read-port 563 which is connected to a multiplexer 564 having the four bit-serial outputs 516-519.

Operation of the device shown in FIG. 5 will now be described:—

Packet data input on lines 502-505 are demultiplexed on to the bit-parallel line 521 and the resulting bit-parallel data is applied to header translation circuitry before segmenting and storage in the input queue memory with each segment having a local header provided by the header translation circuitry. The output port 523 is bit-serial and is connected by the multiplexer 524 to an available one of the six VCSELs 531-536. By “available” it is meant that the VCSEL is not already being used to transfer data, and that a path through the shutter is available to the sector containing the output port required. To explain this more fully, it may be that the VCSEL 531 is available to transfer data whereas all remaining VCSELs 532-536 are already occupied. If however the shutter group 538-543 is already engaged in transferring data to the photo-sensing diode 545 then there is no path available from the VCSEL 531 which could reach the required output line 516. In this case the data for transfer to the line 516 is retained in the queue store.

If however there is available a VCSEL for transfer to the output stage 508 and if there is available a shutter having a path from the VCSEL to one of the photo-sensing diodes 545-550 then the information is routed to that VCSEL and a routing is set up and fixed until the entire content of the queue is passed across the optical link. In the present case the queues are organised by output port. It would of course be possible to order the queues by output sector and to carry out the sorting between the output ports in the output stage but this would result in additional complexity if there was a need to maintain packets in the order of their arrival.

Assuming that VCSEL 531 is used to transfer data destined for output port 516, then this data is output in serial form from VCSEL 531 to the shutter 538 and similarly to a shutter of each of the other sectors. If the data is only for the output 516 then the remaining shutters receiving the light from VCSEL 531 are maintained closed and only shutter 538 is made transparent. In any event, all of the remaining shutters 539-543 of the first group are made opaque so that the only light received by the photo-sensing diode 545 comes from the VCSEL 531. The serial data from the photo-sensing diode 545 passes into the shift register 557 which is self-clocked and when the shift register is full the data of a segment is transferred to the buffer store 558 and the shift register cleared. The remaining data of the packet stream from the input queue is transferred in like fashion from the shift register into sequential memory locations of the buffer store 558. When the queue is empty, the data is output on the bit-parallel line 559 and picked up by the demultiplexer 560 being passed in bit-parallel form over bus 561 to the circuit block 562. The segments have their local header data removed by the circuit block 562 and the packets are reassembled in the output queue store. The reassembly typically takes the form of linking pointers between the different memory locations of the output queue store so that the end of each segment indexes the start of the next. The output queue store then passes data through the multiplexer 564 to the output line 516.

It will be seen from this description that control of the flow of packets across the core switch depends only upon knowledge of the input queue state and the available paths. It is not a requirement that information be signalled at the packet rate from the output stage 508. However of course the overall management of the router system takes into account the size of the queues in the output queue store to prevent hotspots from arising. It will be seen that the six VCSELs 531-536 are all capable of transferring information to the desired output sector and that there is no linkage between a VCSEL and any one output sector as in the case of the non-sectored device.

Referring now to FIG. 6 another example of a router will now be described. The router 208 has four input modules 210-213 of which input modules 210-212 each receive inputs from four input lines 231, 232, 233 and 234. Each of the input modules 210-213 has its own sector memory so that packets from each of the three sets 231, 232, 233 of four input lines is carried via a respective write bus to the sector memory. The packets on the sets of input lines 231-233 carry network routing information in the form of headers. These headers are read within the sectors 210-212 and the packets are segmented as previously described with each segment having a pre-pended local header indicative of the destination mode within the router to which the packet is sent.

The fourth input module 213 has six inputs 234 from a passive optical network which extends from a preceding router. The packet information carried on the six inputs 234 consists of packet segments each carrying a pre-pended local header part indicative of a virtual destination within the input sector 213. The input sector 213 removes the local header information, examines the network header information contained within the packet and adds a new local header for the router 208 before queuing the segments in a sector memory.

Each of the input modules 210-213 has six VCSEL outputs and these are applied using fan-out optics 214 via free-space paths to a shutter module 209, the module having first to fourth shutter sectors 215-218. Each of the shutter sectors has twenty-four shutters and is operated by the control circuitry 235 so as to set only six of the twenty-four shutters to the “on” condition.

The output of the first shutter section 215 is fed via fan-in optics 219 to an output module 223 which receives the six inputs, stores these in a buffer and then reassembles the segments before outputting to the required one of four output lines 227. Similarly the second shutter section 216 has fan-in optics 220 leading to an output module 224 which has four outputs 228. The third shutter section 217 also has fan-in optics 221 but instead of these leading to an output module there is instead an optical regenerator device 225 which receives the six input signals from free-space and launches those signals into a passive optical network, here an optical transmission link consisting of six optical fibres 229 for monomode transmission. In other embodiments the link consists of a single WDM fibre. The six fibres lead to an Internet termination which may be remote from the router 208. The Internet termination includes de-segmenting circuitry which reassembles the packets and removes the local header information before launching the output packets to the Internet.

The fourth shutter section 218 has fan-in optics 222 which also leads to an optical regenerator 226 feeding the transmission link. The transmission link forming part of a passive optical network, lead to a second router which is remote from the router 208.

In much the same way as the input sector 213 of the router 208, the input sector of this remote router is able to combine the functions of the output stage of the router 208 and the input stage of the remote router. This is advantageous because the operation of the router 208 does not require knowledge of the status of the output stage of the router. The immediately-required information is confined only to the conditions of the input queue and the shutters. Thus, the control circuitry 235 which is physically close to the router can operate with a rapid response time without the delays that would be incurred if information from a remote output stage were required to control packet flow. By combining together the input and output queues in the input module of the router 208 (and likewise the remote router) the number of queues in the network is reduced overall. This has the advantage of reducing memory requirements and also of reducing network delay.

There is also provided an overall management structure for the network. Typically, the management device will contain routing tables and will be connected to the routers to observe the packet flow—for example by checking queue status. The controller then can take account of locations where queue lengths are increasing so that internal traffic can take a less congested path through the network.

Queuing strategies will now be described for the situation where no path from one of the input module 211 is immediately available:

In one arrangement, the input queues are a function of destination port and a FIFO operation is used.

In another, service criteria are provided so that packets of given priority have a guaranteed performance through the network. Within these embodiments, higher priority packets are moved upwards towards the head of such queues by pointer manipulation. Where congestion occurs, this is indicated by input or output queue overloading. Queue overloading is reported to the network management which calculates whether a different route through the MAN would remove the congestion.

If so, the routing tables in the relevant nodes of the MAN are changed to effect this, and the existing queues at the hot spot would be left to empty as soon as possible. Any fresh packets that would encounter the existing bottleneck would take the new path through the MAN. In some embodiments, the routers take precautions to prevent packets getting out of order by storing packets that should occur later but do in fact arrive earlier. In other embodiments, the receiving device instead performs this function.

In other arrangements, a weighted fair queuing algorithm is used to control the device.

In yet other arrangements, queue stores are a function of the destination sector.

In many router architectures, the speed-up is high—for example a cross-point device having N inputs and N output has a speed-up of N. The use of the present device with sectoring and a high speed optical path, together with the use of general knockout allows speed-up to be typically of the order of 1.75 to 2.0, with an acceptable blocking performance. Providing extra paths can reduce blocking in the packet router device 208. Where spatial speed-up is in effect some paths may also be fixed. The ratio of fixed paths to switchable paths may typically be 2:1.

Alternatively and/or additionally to spatial speed-up, temporal speed-up may be provided. Temporal speed-up is where information is transmitted over a device output line at a higher rate than it is received at the input to the device.

FIG. 7 shows a high-level block diagram of an embodiment of one sector of the input stage to the core switch of a sectored router using a path-on-request technique for transport of packet data across the core switch. As has previously been noted, packets are segmented at least in part due to their arbitrary length. This first stage segmentation takes place upstream of FIG. 7, as does network header reading and the addition into the first stage segments of local headers. Referring to FIG. 7, packet segments 750 are serially input to a local header read device 800 and thereafter read into input buffers 801. The local header information is passed to the control device. The parallel output of the input buffers is then read into a common memory switch 802. There are time constraints on control processing and shutter latency which are eased if the input is held for a delay after the packet segment header is read and passed onto the control function. This means that the peak rate of packet arrival can be reduced to become nearer the mean rate. To allow for the delay, common memory switch 802 is split into two sections—a delay section with a delay equal to the required latency value and a queue section.

Output 751 from common memory switch 802 is transferred serially when appropriate through an output packet buffer 803 into a re-timing buffer circuit 804 for output to the VCSELs. The re-timing buffer circuit contains one re-timing buffer per VCSEL, and an embodiment of such a buffer is described later herein with respect to FIG. 8.

In other embodiments, electronic cross-connects or cross-points are used, but the arrangement using a common memory switch described above provides a useful interface between the router and the core switch, as the internal queue reduces the requirement on the number of switch paths. Equally, the fact that delay can be readily included simplifies the design.

The input electronics further divides the segmented packet into a “tranche” of R words of length W, after adding the local header in front of the first word in each segment. Stuffing bits (SB) 614 are inserted locally between each word to give a total word length of W+SB. As far as the core switch is concerned it is dealing with tranches and needs to know nothing about how tranches are related to the input packets.

FIG. 8 shows a block diagram of an example of a re-timing buffer, having a buffer store split into three buffers 610-12 each with a length 0.5W, thus providing a total length 1.5 W. A serial input 751 is commutated by a cyclic commutator 613 between the three buffers such that data is read into and out (by a second commutator 615) of them cyclically. Three, rather than two, buffer stores each with a length 0.5W corresponding to the time available for setting a shutter, are used because the insertion of stuffing bits requires read out to be faster than read in. The three buffer solution avoids the need to clock in and out at different rates simultaneously.

Each re-timing buffer is assigned a time slot modulo N1, N1 being given by N1=N(1+k), where k is the speed-up of the switch. The input is sorted according to output sector. Because the fan-in at the input of the output stage of the switch causes data from all input sectors to be overlaid on each other, it is necessary to ensure that no two (or more) input sectors use the same numbered buffer to send to the same output sector. If for example buffer i of sector 1 is directed to sector 4, no other sector's i buffer is directed to sector 4. Thus an input on sector 2 directed to sector 4 uses another port, j say.

A control algorithm tells the input which output buffers are allocated and then informs the shutter plane which shutters to open.

A lower level block diagram of an implementation of the functional architecture of FIG. 7 is shown in FIG. 9. The implementation is split into three parts namely an input buffer part 801, a central part 802 and an output part 803. In the input part 803, input data 800 is transformed from serial to parallel format. The parallel data is transferred into the central section 802, which comprises a FIFO, where it is delayed to allow for the latency issue discussed above, and queued until output is possible. In the output section the data is stored in a buffer termed an output packet buffer, prior to transfer into the re-timing buffer. Because of the time (latency) needed to set up the path due to the use of the optical shutters, the size of the centre section FIFO will depend on that latency. As the overall device allows speed-up to be kept small, for instance typically less than 3, the effect of a queue on the value of speed-up is not significant

Input Sequence to Input Stage

1. Detect headers and store in the input packet assembly block 801.

2. Scan 805 header stores and transfer headers to address comparator/logic 806 where any necessary translation takes place. The address of the input packet is implicit in the time slot and a single bit denotes the position of the commutator.

3. Using read/write logic 812 write the next free address location of the FIFO store of the centre stage from a free address location store 811 into an input stream pointer store 807. Set a flag bit. In the relevant time slot, transfer the content of the input buffer to the delay section of the store 802 of the centre stage. Reset the flag bit.

4. Ask control to set up the switch path and after the pre-set delay move the packet from the delay section to the queue section of the store 802 of the centre stage.

5. Write the address location of the store 802 of the centre stage, together with writing the destination stream address into an output stream pointer store 808. Using a pointer logic circuit 813, write a pointer to the output stream pointer store into an output stream pointer FIFO 809.

Output Sequence from the Input Stage.

1. Scan periodically the output packet buffer 803 and when empty slots are found, set bits in a free-slot bit map 810. Translate the bit map settings into destination addresses and set bits in the destination bit map 810.

2. Asynchronously scan the output stream pointer queues from the point where the last scan finished. On finding a queue with content, and if the relevant bit in the destination bit map is set, set a bit in an output stream pointer store 808 and pop the output stream pointer FIFO 809. The destination address in the output stream packet store is replaced by the output packet buffer address. In the relevant time slot a transfer is made between the store 802 of the centre section into the output packet buffer 803 and the output stream pointer is returned to the output store pointer FIFO 809.

The time slot intervals (t) for the store of the centre section are proportional to the fan-out, the number of words per segment, and the store width in bits, and inversely proportional to the number of input streams and the bit rate in bits/sec.

In embodiments where increase of the time slot duration is required, the main store is split into sections for access.

FIG. 10 shows a block schematic diagram of an embodiment of the output stage electronics. After conversion from serial optical to serial electronic streams by photodetectors, e.g. optoelectronic diodes, the serial data are stored in shift registers 901 where the local destination headers can be read. The outputs of the shift registers 901 are read out in parallel on a bus 902 of width W into a packet store memory 903, a dual port SRAM, (which acts as an intra-sector switch) where they are queued until their destination port is free. The larger W, the easier are the requirements on bus speed and memory write time.

The rate S at which the shift registers need to be addressed is: S=B n/W times/s where B is the input bit rate and n is the number of inputs to each sector.

Input Sequence to Output Stage

1. Detect local header

2. Having detected local header, start a word count and when the address field is found staticise it.

3. Allot two time slots, modulo N or n′, in the write cycle of the packet store memory 903.

4. In the first slot of the first word of a tranche, read out the address field to a central controller 904.

In the central controller, compare the most significant bits of it with the own sector address, and return 1 for me, 0 not for me.

If 0 no further action is taken on this stream and the contents of the shift register are shifted out and lost.

If 1 store the least significant address bits (LSB), indicating the output port number (OPN), in an incoming stream buffer for the stream, which buffer also has a tranche counter.

Set the tranche counter to R-1.

Take the starting address of the packet store, where incoming data is to be stored as a block, from an incoming address location FIFO holding the incoming address locations.

Store the starting address in the incoming stream buffer.

If the incoming address location FIFO is empty (indicating queue overflow) discard the packet data and inform central control.

5. For all values of R, in the second modulo N or n′ slot, examine the relevant input stream buffer to determine whether the stream is active or not.

If the stream is active, take the store address from it and load into the write address buffer of the packet store memory.

Connect the contents of the relevant shift register which is in the idle phase (i.e. not shifting) at this time, to the packet store write bus to transfer the contents to the packet store. (It is possible to set the shift register to idle because of the stuffing bits at the front of the words additional to the first word in each tranche.)

Decrement the tranche counter in the incoming stream buffer.

If the tranche count is zero, set the incoming stream buffer to idle.

6. On the transfer of the first tranche to the packet store, use the LSB from the incoming stream buffer to address an output stream pointer FIFO holding the relevant output stream pointer, place the packet store address is placed there. As one bit of the LSB indicates a multiple address, where this bit is set a translation is required and addresses are placed in several output stream pointer FIFOs

B Output Sequence.

Asynchronous Part

1. Scan output stream buffers 905. When an idle one is found, scan the output stream pointer queue from where the last scan finished. On finding a queue with content, perform the following on the stream output buffer.

set state to ‘active’,

transfer store pointer from stream pointer FIFO,

load FIFO number (i.e. output port number OPN),

set tranche count,

set bit count

set ‘ready bit’.

Synchronous Part.

2. Each output stream buffer is allocated a fixed time slot modulo OPN and the scan cycle time T has an integer relationship such that T=WB/I where T is an integer, I is an integer (I≧1) and B is the bit rate.

Examine the stream buffers in their time slot.

If ready, transfer the address of the output stream data to the read address buffer of the packet store and read the packet store content read into the output buffer 905 ready for parallel to serial transformation. Reset the ready flag, increment the tranche count and start counting word-bits.

When the bit count reaches zero, set the ready flag and transfer the next tranche.

3. While the transfer takes place between the packet store and output buffer, insert idle bits in the serial stream.

4. When the tranche count reaches zero and the last word is transferred, return the store pointer the address FIFO.

In some embodiments, sequences of control actions are pipelined rather than attempting to perform all the actions of a sequence in one packet store cycle.

The above discussion of FIGS. 7-9 only constitutes one illustrative example of the possible control method and implementation.

A controller (e.g. a microprocessor) is also provided to initialise the system for example loading own-sector addresses and FIFO addresses, to synchronise it and to accept fault reports. A system reset is provided and start-synchronising pulse for the scanners.

Metropolitan Area Networks

Referring now to FIG. 11, an example of a Metropolitan Area Network 910 has three external connections 912-914 to the Internet, these three connections being made to three nodes 915-917 of the MAN.

The MAN also has seven internal nodes 918-924. The internal nodes 918-924 and the external nodes 915-917 are shown connected by an exemplary network of transmission links 925-939.

As is known in the art, the external nodes 915-917 contain full Internet routing tables, and allow translation of Internet addresses into an abbreviated address format which is internal to the MAN.

The MAN also has a network control device 911 which has by directional connections 940 to all of the nodes of MAN. The network control 911 performs a number of functions, including which is the function of loading and updating routing tables in the internal nodes as a result of monitoring the state of MAN as a whole with a view to reducing or removing the occurrence of traffic bottle necks. By way of example, if information comes in at external link 912 with a destination address indicative of internal node 923 then routing can occur via link 925 or 927 at the external node 915. Clearly there are a number of paths within the MAN that lead to the destination node 923 so that, for example, at a particular point in time, the routing table at node 915 may be set to route traffic to node 923 via links 925, 929 and 937. If however a bottle neck occurs at link 931 for example due to traffic from node 919 to node 922 then the routing tables may be amended so as instead to route via links 925, 928 and 936. As known to those skilled in the art, various perimeters may be used to detect when the routing tables require updating.

Turning now to FIG. 12, this shows how a passive cross connect, for example, a passive optical network 949 can be used with a MAN 950 to connect nodes of the MAN to each other and to route external to the MAN, for example to the Internet. FIG. 12a shows a part of the MAN 950 having one external node 951 with a minor trunk 956. Two internal nodes 952 and 953 are shown. 958 and 959 represent the trunk inputs to node 952 and 953 respectively. There are two major trunks 954 and 955 connected to routes external to MAN. The node 951 is connected to a four nodes 961.

The cross connect 949 is expended in FIG. 12b to show how connections are organised in more detail. Each of the three routers 951-953 is split into output sections 951a-953a and input sections 951b-953b. These sections are jointed by optical interconnect as previous described. Each of the routers has three sectors with two inputs and two outputs per sector. The number of connections between input and output, with speedup, is three per sector pair. On the input side of the trunks 954a and 955a, in coming packs are reformatted at blocks of 961 and 962 to conform to the internal address structure of the MAN. The reformatted packs are input to the nodes 952b and 953b via lines 958 and 959. The trunk outputs come from 952a and 953a via 958 and 959 to the electronic output modules 963 and 964. There the packet data is queued as necessary and then output via 965 and 966 in the external network format to the trunk connections 955b and 955c. The electronic output modules 963 and 964 operate similarly to the electronic output modules in FIG. 6.

Embodiments of the present invention have been described with particular reference to the examples illustrated. However, it will be appreciated that variations and modifications may be made to the examples described within the scope of the present invention.

1. A packet router comprising an input stage, an output stage and a coupling stage for coupling the input and output stages,
the input stage having plural input devices each for receiving packets having packet data comprising packet destination data, each input device having at least one output element;
the output stage having plural output devices defining plural router output nodes, each output device having at least one input element;
the coupling stage providing paths for signals between said output elements of the input devices and said input elements of the output devices;
wherein each input device has circuitry arranged to respond to packet destination data of a packet received by said input device for adding, to the packet data of the packet, information indicative of a router output node at which the packet is to be output;
wherein the router further comprises a control device connected to said input stage and to said coupling stage for causing packets to be output to said coupling stage in dependence on said information;
wherein each output device has circuitry for removing said information prior to output of packets; and
wherein the router further comprises a connecting device arranged to receive said signals from paths of the coupling stage and to transfer said signals to a further said output device disposed remote from said input stage.

2. A packet router according to claim 1, wherein each said input device has a plurality of inputs, a plurality of output elements, and comprises a respective memory arranged to receive data from all of the said plurality of inputs and arranged to output data to all of said plurality of output elements; and wherein each output device has a plurality of input elements and a plurality of router output nodes, and comprises a respective memory arranged to receive data from all of the said plurality of input elements and arranged to output data to all of said plurality of output nodes.

3. A packet router according to claim 1, wherein said coupling stage is arranged to vary the paths between the input stage and the output stage, and said control device is arranged to cause packets to issue from the input stage when a desired path is provided.

4. A packet router according to claim 1, wherein said control device is arranged to control the coupling stage to set up a desired path from the input stage to the output stage and to cause packets to issue from the input stage for the desired path.

5. A packet router according to claim 1, wherein the coupling stage is arranged to provide at least one fixed path.

6. A packet router according to claim 1, wherein the input devices comprise segmenting circuitry arranged to divide received packets into segments of common length prior to application to said coupling stage, wherein each segment includes the said router output node information of the packet and the output devices comprise desegmenting circuitry arranged to assemble segments received from said coupling stage into packets.

7. A packet router according to claim 1, wherein the input devices have optical output elements and the output devices have optical input elements and the coupling stage is arranged to provide free-space optical paths between said optical output elements and optical input elements.

8. A packet router according to claim 1 wherein the connecting device comprises a passive optical network.

9. A packet router according to claim 8, wherein the input stage has a plurality of inputs capable of carrying a first plurality of packets to said router in a given time period, and the coupling stage is capable of providing said paths between said output elements of the input devices and said input elements of the output devices, wherein said paths are arranged to be able to carry more than said first plurality of packets in said given time.

10. A packet router according to claim 9, wherein the number of spatially separate paths provided by said coupling stage is greater than the number of inputs to said input stage.

11. A network comprising a packet router according to claim 1 wherein each input device comprises storage for holding queues of packet data prior to issue to said coupling stage, and each output device has storage for queues of packet data received from the coupling stage, and further comprising at least a second packet router, the said at least a second packet router having a second router input stage, a second router output stage and a second router coupling stage for coupling the second router input and output stages, wherein the second router input stage has plural input devices each for receiving packets having packet data comprising packet destination data, each second router input device having at least one output element and storage for holding queues of packet data prior to issue to said second router coupling stage, wherein the second router output stage has plural output devices defining plural output nodes, each output device having at least one input element, wherein the second router coupling stage is arranged to provide paths between said output elements of the input devices and said input elements of the output devices, and wherein at least one of the input devices of the second router input stage is provided by said further said output device of said packet router disposed remote from said input stage of said first packet router, wherein each queue of packet data received from the coupling stage of the first packet router forms a queue of packet data for issue to the coupling stage of the second router.

12. A network comprising a first and at least one second packet router, each packet router comprising an input stage having plural input devices, an output stage having plural output devices and a coupling stage for providing paths between said input devices and said output devices; each input device having storage for holding queues of packet data prior to issue to said coupling stage, each output device having storage for queues of packet data received from the coupling stage;
wherein at least one of the input devices of the second packet router is provided by an output device of said first packet router such that each said queue of packet data received from the coupling stage of the first packet router forms a queue of packet data prior to issue to said coupling stage of said second router.

13. A network according to claim 12, wherein each said input device has a plurality of inputs and a plurality of output elements and a respective memory providing said storage for holding queues of packet data prior to issue to said coupling stage arranged to receive data from all of the said plurality of inputs and arranged to output data to all of said plurality of output elements, and wherein each output device has a plurality of input elements and a plurality of router output nodes and a respective memory providing said storage for queues of packet data received from the coupling stage and arranged to receive data from all of the said plurality of input elements and arranged to output data to all of said plurality of output nodes.

14. A network according to claim 12, wherein each packet router has a respective control device connected to its input stage and to its coupling stage for outputting packets to said coupling stage in dependence on routing information carried by packets.

15. A network according to claim 14, further comprising a management device connected to receive information on the size of queues in each said output device.

16. A network according to claim 15 wherein the management device is connected to each control device for modifying routing tables in accordance with said queue size information.

17. A network according to claim 12, having means for discarding packets in said output stages if queues therein overflow.

18. A network according to claim 12 wherein the coupling stage of at least the first packet router is arranged to optically couple the input stage of the first packet router to the output stage of the first router.

19. A network according to claim 18, wherein the said coupling stage is arranged to provide free-space connections.

20. A method of routing packets using a packet router comprising an input stage, plural output devices and a coupling stage for coupling the input stage and output devices, wherein at least one of the output devices is spatially remote from the coupling stage;
the method comprising:—
in said input stage, examining packet destination data of a packet received by said input stage and in response thereto
adding, to the packet, router information indicative of a router output node of said at least one of said output devices, at which the packet is to be output to provide enhanced packet data;
in dependence on said router information, determining whether a path is available from an input of said coupling stage to an output connected to said at least one output device;
outputting said enhanced packet data to said input of said coupling stage, whereby the enhanced packet data is carried to an output of said coupling stage for said at least one output device having the said router node;
receiving the enhanced packet data from said coupling stage output and transferring the packet data over a link to said at least one output device;
receiving said enhanced packet data in the said output device;
removing said router information; and
outputting said packet at said router output node.

21. A method of routing packets using a router comprising an input stage having plural output elements, plural output devices each having plural input elements, the plural output devices each having a plurality of output nodes, said output nodes together defining the output nodes of said router, and a coupling stage for coupling the plural output elements of the input stage to plural coupling stage outputs, wherein at least one output device is spatially remote from the coupling stage and the router further comprises a link between predetermined outputs of said coupling stage and the plural inputs of said at least one output device;
the method comprising:—
receiving respective packets at each of plural inputs of said input stage;
in response to packet destination data of said packets, adding to each packet respective router node information indicative of a router output node at which the said packet is to be output, thereby to form enhanced packet data comprising said packet data and said router node information;
storing said enhanced packet data for each packet in a common input memory;
in dependence on said router node information indicative of an output node in said at least one output device, determining an available path through said coupling stage from an output element of said input stage to one of said predetermined outputs of said coupling stage;
outputting said enhanced packet data from said common input memory to said output element, whereby the enhanced packet data is carried to one of said predetermined outputs of said coupling stage;
transferring the enhanced packet data over said link to one of said plural inputs of said at least one output device;
receiving said enhanced packet data at the said output device;
removing said router node information indicative of said output node to form packet data;
storing said packet data in a memory common to the input elements of said output device and to the output nodes of said output device; and
outputting a packet at said router output node from said memory.

22. A method according to claim 21, comprising varying paths provided by said coupling stage between the input stage and the output stage, and causing packets to issue from the input stage when a desired path is provided.

23. A method according to claim 22, wherein said varying step comprises providing a sequence of path combinations, and selecting between said path combinations on a timed basis.

24. A method according to claim 22, wherein said varying step comprises providing a set of path combinations, and selecting between the members of said set in accordance with a statistical analysis of traffic in said router.

25. A method according to claim 22, comprising controlling the coupling stage to set up a desired path from the input stage to the output stage and issuing packets from the input stage to the desired path.

26. A method according to claim 22, wherein the coupling stage is arranged to provide at least one fixed path.

27. A method according to claim 22, comprising dividing received packets into segments of common length prior to application to said coupling stage, and adding the said router node information to each segment.

28. A method according to claim 22, comprising coupling between the input stage and the output devices using free-space optical paths.

29. A method according to claim 28, wherein transferring step is carried out using a passive optical network.

30. A method according to claim 22, comprising carrying data across said coupling stage faster than said data is received at said input stage.

31. A method according to claim 22, comprising providing a number of spatially separate paths in said coupling stage wherein said number is greater than a number of inputs to said input stage.

32. A method according to claim 22, comprising:
holding queues of enhanced packet data prior to issue to said coupling stage,
holding queues of packet data received from the coupling stage,
locating at least one of said queues of packet data received from the coupling stage at an input of a second router having a second router coupling stage, said second router holding queues of packet data prior to issue to said second router coupling stage, and using said at least one of said queues as a said queue of packet data prior to issue to said second router coupling stage.

33. A method according to claim 22, comprising providing information on the size of queues of data received from said coupling stage, and using said information to effect changes on routing information.
